(19) United States
(12) Patent Application Publication
(10) Pub. No.: US 2010/0245441 A1
(43) Pub. Date: Sep. 30, 2010

(54) FLUID EJECTING APPARATUS AND METHOD OF CORRECTING PIXEL DATA

(75) Inventors: Michiaki Tokunaga, Matsumoto-shi (JP); Masahiko Yoshida, Shiojisi-shi (JP); Takeshi Yoshida, Shiojiri-shi (JP); Tatsuya Nakano, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/732,094

(22) Filed: Mar. 25, 2010

(30) Foreign Application Priority Data
Mar. 26, 2009 (JP) 2009-077328

(51) Int. Cl. B41J 29/393; G06K 15/10

(52) U.S. Cl. 347/14; 358/1.8

(57) ABSTRACT

A fluid ejecting apparatus and a method for correcting pixel data are disclosed. The fluid ejecting apparatus includes a nozzle line having nozzles which eject fluid onto a medium and are lined up in a predetermined direction; a moving mechanism relatively moving the nozzle line and the medium in a direction intersecting the predetermined direction; and a control unit that ejects the fluid from the nozzle line while relatively moving the nozzle line and the medium in the intersecting direction by using the moving mechanism, based on pixel data of the predetermined number of gradations according to certain kinds of dots which can be formed by the fluid ejected from the nozzles, the control unit correcting the pixel data of the predetermined number of gradations in accordance with the correction value set for every image line data which is the plurality of pixel data lined up in a direction corresponding to the intersecting direction in the pixel data.

### BACKGROUND

1. Technical Field

The present invention relates to a fluid ejecting apparatus and a method of correcting pixel data.

2. Related Art

As one kind of a fluid ejecting apparatus, there is known an ink jet printer (hereinafter, referred to as a printer) which performs printing by ejecting ink on various kinds of media, such as paper, fabric or film, from nozzles. Image data formed by a user is expressed by the high number of gradations. For this reason the data of the high number of gradations is half-tone processed by the printer driver to data of the low number gradations which can be formed by the printer. Then, the printer performs the printing based on the half-tone processed data.

In such a printer, there is a case in which, due to problems such as the working accuracy of the nozzles or like, ink droplets do not land on the medium at their proper positions, or variations in the quantity of ink ejection occurs, thereby causing unevenness in concentration. For example, in the case in which ink droplets fly on a skew from a certain nozzle, it exerts an effect upon not only concentration of an image section which is formed by the nozzle, but also concentration of an image section adjacent to the image section. Further, according to a printing method, the nozzle for forming the image section and a nozzle for forming an image section adjacent to the image section do not always correspond with each other. For this reason, it is not possible to suppress the concentration unevenness by correction values which are merely corresponded to the nozzles.

Accordingly, a method for calculating the correction values for every region (hereinafter, referred to as a line region) on the medium, on which the image section is formed, has been proposed (e.g., see JP-A-2007-1141). The correction value is a correction value for performing concentration correction processing with respect to data of the high number of gradations which is prior to the half-tone processing.

Without limiting a case where the data which is subjected to the concentration correction processing and the half-tone processing by a printer driver is transmitted to the printer, there is a case where data which is not subjected to the concentration correction processing but subjected to the half-tone processing by other application program is transmitted to the printer. If the printing is performed based on the intact print data intact which is transmitted from another application program, unevenness in concentration occurs in the printed image.

### SUMMARY

An advantage of some aspects of the invention is that it suppresses unevenness in concentration.

According to an embodiment of the invention, there is provided a fluid ejecting apparatus including a nozzle line having nozzles which eject fluid onto a medium and are lined up in a predetermined direction; a moving mechanism relatively moving the nozzle line and the medium in a direction intersecting the predetermined direction; and a control unit that ejects the fluid from the nozzle line while relatively moving the nozzle line and the medium in the intersecting direction by using the moving mechanism, based on pixel data of the predetermined number of gradations according to certain kinds of dots which can be formed by the fluid ejected from the nozzles, the control unit correcting the pixel data of the predetermined number of gradations in accordance with the correction value set for every image line data which is the plurality of pixel data lined up in a direction corresponding to the intersecting direction in the pixel data.

Other characteristics of the invention will be apparent from the description of the specification and the accompanying drawings.

### BRIEF DESCRIPTION OF THE DRAWINGS

The invention will be described with reference to the accompanying drawings, wherein like numbers reference like elements.

FIG. 1A is a block diagram showing the overall configuration of a printer, and FIG. 1B is a perspective view showing a portion of the printer.

FIG. 2 is a view showing a nozzle line on a bottom surface of a head.

FIG. 3A and FIG. 3B are explanatory views of common printing.

FIG. 4 is an explanatory view of leading-end printing and trailing-end printing.

FIG. 5A is an explanatory view showing a case in which dots are ideally formed, FIG. 5B is an explanatory view showing a case in which unevenness in concentration occurs, and FIG. 5C is an explanatory view showing a case in which dots are formed in accordance with correction values.

FIG. 6A is a view showing a test pattern, and FIG. 6B is a view showing a correction pattern.

FIG. 7 is a view showing the results read by a scanner with respect to a correction pattern of cyan.

FIG. 8A and FIG. 8B are views showing a method of calculating a correction value for the concentration unevenness.

FIG. 9 is a view showing a correction value table.

FIG. 10 is a view showing a shape of calculating a correction value corresponding to each of gradation values.

FIG. 11A is a flowchart showing a concentration correction processing (printing process) of a comparative embodiment, and FIG. 11B is a flowchart showing a concentration correction processing (printing process) of the embodiment.

FIG. 12A is an explanatory view showing a table on a formation rate of dots, FIG. 12B is a view showing a shape of ON/OFF judgment of a dot by a dither method, and FIG. 12C is a view showing a shape of an error diffusion method.

FIG. 13 is a flowchart of an identification unit.

FIG. 14A shows a correction value of Example 1, and FIG. 14B and FIG. 14C are views showing a shape of correcting pixel data of 4 gradations.

FIG. 15A shows a correction value of Example 2, and FIG. 15B and FIG. 15C are views showing a shape of correcting pixel data of 4 gradations.

FIG. 16A shows a correction value of Example 3, and FIG. 16B is a view showing a shape of correcting pixel data of 4 gradations.

### DESCRIPTION OF EXEMPLARY EMBODIMENTS

### Summary of Disclosure

The following points will be apparent from at least the specification and the accompanying drawings.

That is, there is provided a fluid ejecting apparatus including a nozzle line having nozzles which eject fluid onto a medium and are lined up in a predetermined direction; a moving mechanism relatively moving the nozzle line and the medium in a direction intersecting the predetermined direction; and a control unit that ejects the fluid from the nozzle line while relatively moving the nozzle line and the medium in the intersecting direction by using the moving mechanism, based on pixel data of the predetermined number of gradations according to certain kinds of dots which can be formed by the fluid ejected from the nozzles, the control unit correcting the pixel data of the predetermined number of gradations in accordance with the correction value set for every image line data which is the plurality of pixel data lined up in a direction corresponding to the intersecting direction in the pixel data.

With the above fluid ejecting apparatus, it is possible to perform concentration unevenness correction with respect to the data which have been half-tone processed.

In the fluid ejecting apparatus, it is identified whether the received pixel data of the predetermined number of gradations is correction completed data which is converted to pixel data of the predetermined number of gradations after the pixel data of the high number of gradations by the correction value corresponding to the number of gradations higher than the predetermined number of gradations, or is a pre-correction data which is not corrected by the correction value corresponding to the high number of gradations. If the received pixel data of the predetermined number of gradations is the pre-correction data, the pre-correction data is corrected by the correction value.

With the above fluid ejecting apparatus, it is possible to eject the fluid from the nozzle line based on the pixel data reliably corrected.

In the fluid ejecting apparatus, among the plurality of pixel data belonging to the certain pixel line data, the number of pixel data based on the correction value corresponding to the pixel line data are corrected.

With the fluid ejecting apparatus, it is possible to correct the pixel data according to the correction value.

In the fluid ejecting apparatus, the correction value correcting the pixel data of the predetermined number of gradations is a correction value corresponding to the high number of gradations.

With the fluid ejecting apparatus, it is possible to reduce the capacity of the memory that stores the correction value, or the like by effectively using the correction value corresponding to the high number of gradations.

In the fluid ejecting apparatus, the correction value corresponding to the high number of gradations is set to a plurality of gradation values; the correction value corresponding to a first gradation value among the plurality of gradation values is set as a first correction value corresponding to a first dot among the dots which can be formed; the correction value corresponding to a second gradation value among the plurality of gradation values is set as a second correction value corresponding to a second dot among the dots which can be formed; among the pixel data which forms the first dot, of the plurality of pixel data belonging to the certain pixel line data, the number of the pixel data is corrected on the basis of the first correction value corresponding to the pixel line data; and among the pixel data which forms the second dot, of the plurality of pixel data belonging to the certain pixel line data, the number of the pixel data is corrected on the basis of the second correction value corresponding to the pixel line data.

With the fluid ejecting apparatus, it is possible to correct the pixel data by the correction value corresponding to the gradation value.

In the fluid ejecting apparatus, the correction value in accordance with combination of the predetermined number of pixel data of the predetermined number gradations is stored; in order from one side of a corresponding direction in the plurality of pixel data belonging to the pixel line data, the correction value in accordance with the combination of the predetermined number of pixel data is determined for every predetermined number of pixel data; an integrated value is calculated by integrating the determined correction value; and when the integrated value reaches a threshold value, the pixel data are corrected.

With the fluid ejecting apparatus, it is possible to correct the pixel data in accordance with the correction value.

In the fluid ejecting apparatus, in a case in which a region on the medium corresponding to the pixel line data is corrected to be thin, a quantity of the fluid to be ejected from the nozzle is reduced based on the pixel data to be corrected, and in a case in which a region on the medium corresponding to the pixel line data is corrected to be dense, a quantity of the fluid to be ejected from the nozzle is increased based on the pixel data to be corrected.

With the fluid ejecting apparatus, it is possible to correct the concentration unevenness in the image.

Further, there is provided a method for correcting the pixel data, in the fluid ejecting apparatus which relatively moves the nozzle line having nozzles for ejecting the fluid on the medium and arranged in parallel in a predetermined direction, and the medium in a direction intersecting the predetermined direction, in which the fluid is ejected from the nozzle line based on pixel data of the predetermined number of gradations according to certain kinds of dots which can be formed by the fluid ejected from the nozzles, while the nozzle line and the medium are relatively moved in the intersecting direction, wherein the pixel data of the predetermined number of gradations are corrected in accordance with the correction value set for every image line data which is the plurality of pixel data lined up in the intersecting direction in the pixel data.

With the fluid ejecting method, it is possible to correct, for example, the concentration unevenness in the data which have been half-tone processed.

### Regarding the Printing System

A printing system will now be described with reference to an ink jet printer (hereinafter, referred to as a printer 1) serving as an example of a fluid ejecting apparatus, in which the printer 1 is connected to a computer 60.

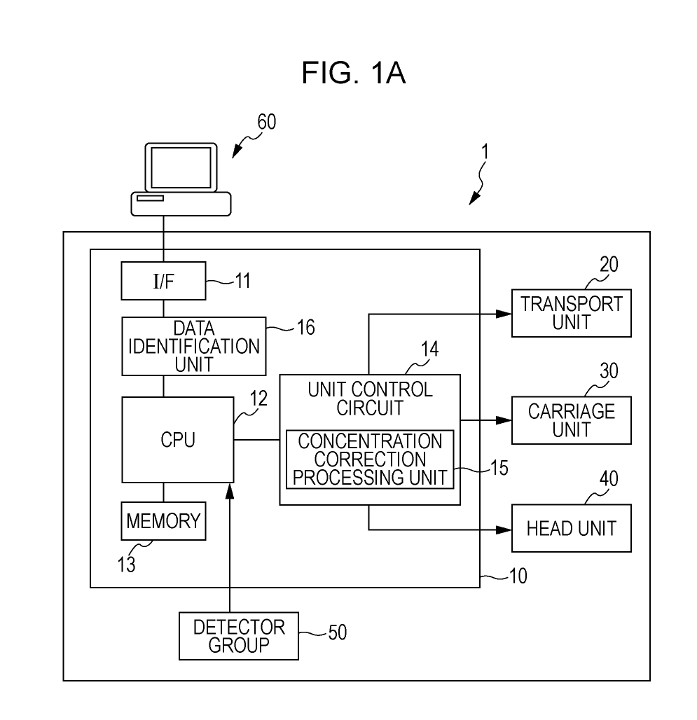

FIG. 1A is a block diagram showing the overall configuration of the printer 1, and FIG. 1B is a perspective view showing a portion of the printer 1. The printer 1 receiving print data from the computer 60 which is a peripheral device controls each unit (a transport unit 20, a carriage unit 30, and a head unit 40) by a controller 10 to form an image on paper S (a medium). Further, a detector group 50 detects an internal status of the printer 1, and the controller 10 controls each unit based on the detected results.

The controller 10 is a control unit for controlling the printer 1. An interface portion 11 is adapted to transmit and receive the data between the printer 1 and the computer 60 which is a peripheral device. A CPU 12 is an operation processing device for controlling the overall printer 1. A memory 13 is adapted to secure a working area and an area for storing programs of the CPU 12. The CPU 12 controls each unit by using a unit control circuit 14.

The transport unit 20 feeds the paper S to a printable position, and transports the paper S in a transport direction (corresponding to a determined direction) at a predetermined transport amount at the time of printing.

A carriage unit 30 (corresponding to a moving mechanism) is adapted to move a head 41 in a direction (hereinafter, referred to as a moving direction and corresponding to an intersecting direction) intersecting the transport direction.

The head unit 40 is adapted to eject the ink on the paper S, and has the head 41. The head 41 is provided on a bottom surface thereof with a plurality of nozzles which serve as an ink ejecting portion. The ink droplets are ejected from the nozzles by driving a piezoelectric element corresponding to the respective nozzles.

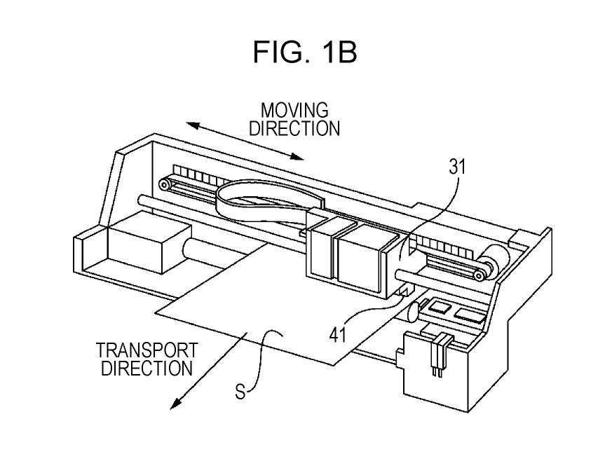

FIG. 2 is a view showing nozzle array on the bottom surface of the head 41. Nozzle lines are formed, in which 180 nozzles (#1 to #180) are arranged in parallel in the transport direction at a predetermined nozzle pitch k·D. The head 41 is provided four nozzle lines to eject the ink of different colors, respectively. The head 41 of this embodiment has a yellow nozzle line Y for ejecting yellow ink, a magenta nozzle line M for ejecting magenta ink, a cyan nozzle line C for ejecting cyan ink, and a black nozzle line K for ejecting black ink.

The serial printer 1 having such a configuration intermittently ejects the ink from the head 41 which is moved in the moving direction by the carriage unit 30 in response to printing data, thereby forming a dot line (a raster line) on the paper S along the moving direction. The dot formation operation and transport operation which transport the paper S in the transport direction by using the transport unit 20 are alternatively performed. As a result, it is possible to form the dots at positions different from the position of the dots which have been formed by the previous dot formation operation, thereby forming a 2D image on the paper.

### Regarding the Printing Data

The printing data transmitted from the computer 60 to the printer 1 is prepared by a printer driver stored in the memory of the computer 60. A brief overview of the preparation processing of the printing data will now be described.

First, at resolution conversion processing, image data output from various application programs is converted into resolution corresponding to the time in which it is printed on the paper S. The image data after the resolution conversion processing is RGB data of 256 gradations expressed by an RGB color space. In this instance, the image data are constituted by a plurality of pixel data.

Next, at color conversion processing, the RGB data are converted into CMYK data corresponding to the ink of the printer 1.

After that, at half-tone processing, the data of a high number of gradations, that is, 256 gradations, are converted into data of a low number of gradations which can be formed by the printer 1. The printer 1 of this embodiment converts the data of 4 gradations so as to form three kinds of dots.

Finally, at rasterizing processing, the image data of a matrix shape is rearranged for every data in the order of transmission to the printer 1.

The data which have been subjected to the above processing are transmitted to the printer 1 by the printer driver as the printing data together with command data according to a printing mode (transport amount or the like).

### Regarding Interlace Printing

The printer 1 of this embodiment generally performs interlace printing. In interlace printing, a raster line of other pass is formed between raster lines which are recorded at one pass. Since a printing method is generally different at the start and end of the printing, common printing, leading-end printing and trailing-end printing are respectively described.

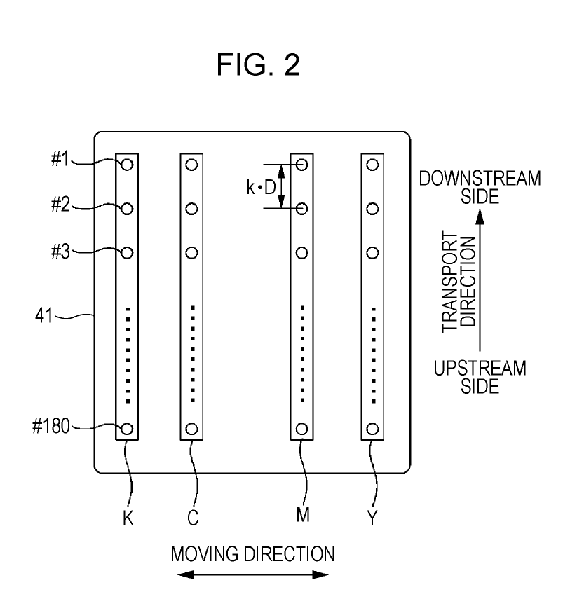

FIGS. 3A and 3B are explanatory views of the common printing. FIG. 3A shows a shape of n-th pass to (n+3)-th pass, and FIG. 3B shows a shape of n-th pass to (n+4)-th pass. For descriptive convenience, the number of the nozzle lines is reduced, and it is shown that the head 41 (the nozzle line) is moved with respect to the paper S, in order to express the relative position between the nozzle line and the paper S. In the figure, the nozzles expressed by black circles are ink ejection nozzles, and the nozzles expressed by white circles are ink non-ejection nozzles. Further, in the figure, the dots expressed by black circles are dots which are formed at a final pass, and the dots expressed by white circles are dots which are formed at the previous pass.

In the common printing of interlace printing, whenever the paper S is transported in the transport direction by a constant transport amount F, the respective nozzles records the raster line just above (at leading end side) the raster line which is recorded at the last pass. In order to perform the record in a constant transport amount, it is subject to the conditions in which the number N (integral number) of the nozzles which can eject the ink has to be in relatively prime relation with k (the nozzle pitch k·D) and the transport amount F has to be set by ND. Wherein, N=7, k=4, and F=7·D. However, in this way, at the start and end of the printing, there are portion in which the raster line is not formed. For this reason, at the leading-end printing and trailing-end printing, a printing method different from the common printing is performed.

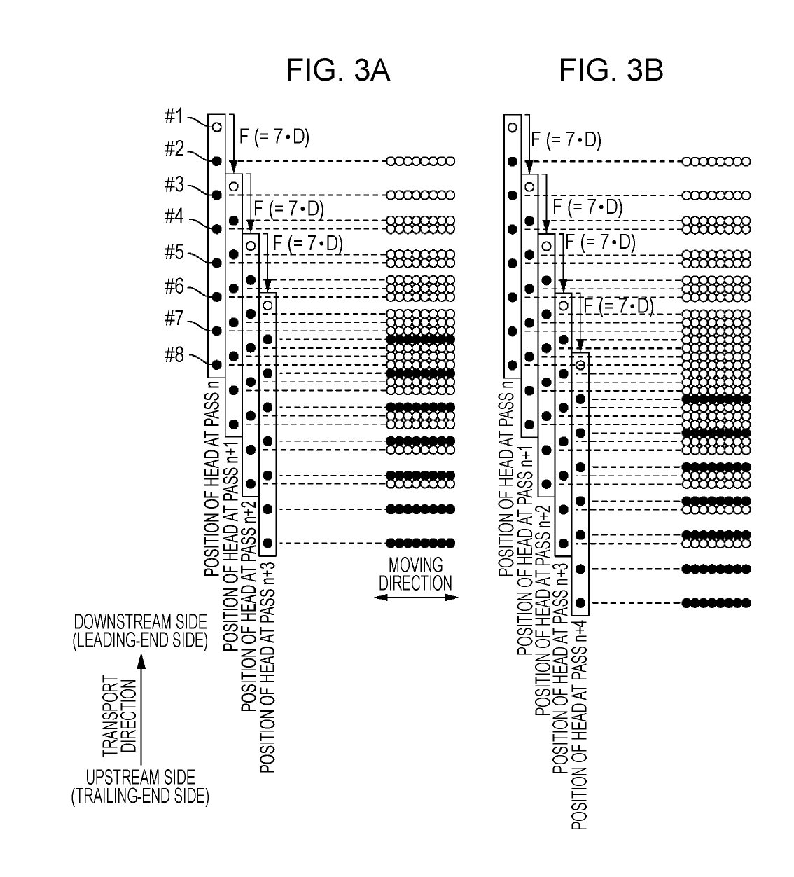

FIG. 4 is an explanatory view of leading-end printing and trailing-end printing. Initial passes of 5 times are leading-end printing, and final passes of 5 times are trailing-end printing. At leading-end printing, the paper S is transported by the transport amount (1·D or 2·D) smaller than the transport amount (7·D) at the common printing. At leading-end printing and trailing-end printing, the nozzles ejecting the ink are not constant. Consequently, at the start and end of the printing, a plurality of raster lines which are continuously extended in parallel in the transport direction can be formed. Further, at leading-end printing, 30 raster lines are formed, and at trailing-end printing, 30 raster lines are formed. By contrast, at the common printing, approximately several thousands of raster lines are formed, which are varied depending upon the size of the paper S.

In a manner in which the raster lines are arranged in the region (hereinafter, referred to as a common printing region) printed by the common printing, there is the regularity every the same number of raster lines as that of the nozzles which can eject the ink (herein, N=7). The raster lines from the raster line which is initially formed at the common printing to 7^{th} raster line are formed by the nozzles #3, #5, #7, #2, #4, #6 and #8, and seven raster lines after the next 8^{th} raster line are formed the respective nozzles in the same order. It is difficult to find the regularity in the arrangement of the raster line in the region (hereinafter, referred to as a leading-end printing region) printed by leading-end printing, and in the region (hereinafter, referred to as a trailing-end printing region) printed by trailing-end printing, as compared with the raster line in the common printing region.

### Regarding the Unevenness in Concentration

For the purpose of the description below, a “pixel region” and a “line region” are set. The term “pixel region” means a rectangular region which is imaginarily set on the paper S, and the size thereof is determined by the print resolution. One “pixel region” on the paper S corresponds to one “pixel data” on the image data. Further, the term “line region” means a region formed by a plurality of pixel regions which are arranged in parallel in the moving direction. The “line region” corresponds to the “pixel line data” in which a plurality of pixel data on the image data is lined up in a direction corresponding to the moving direction.

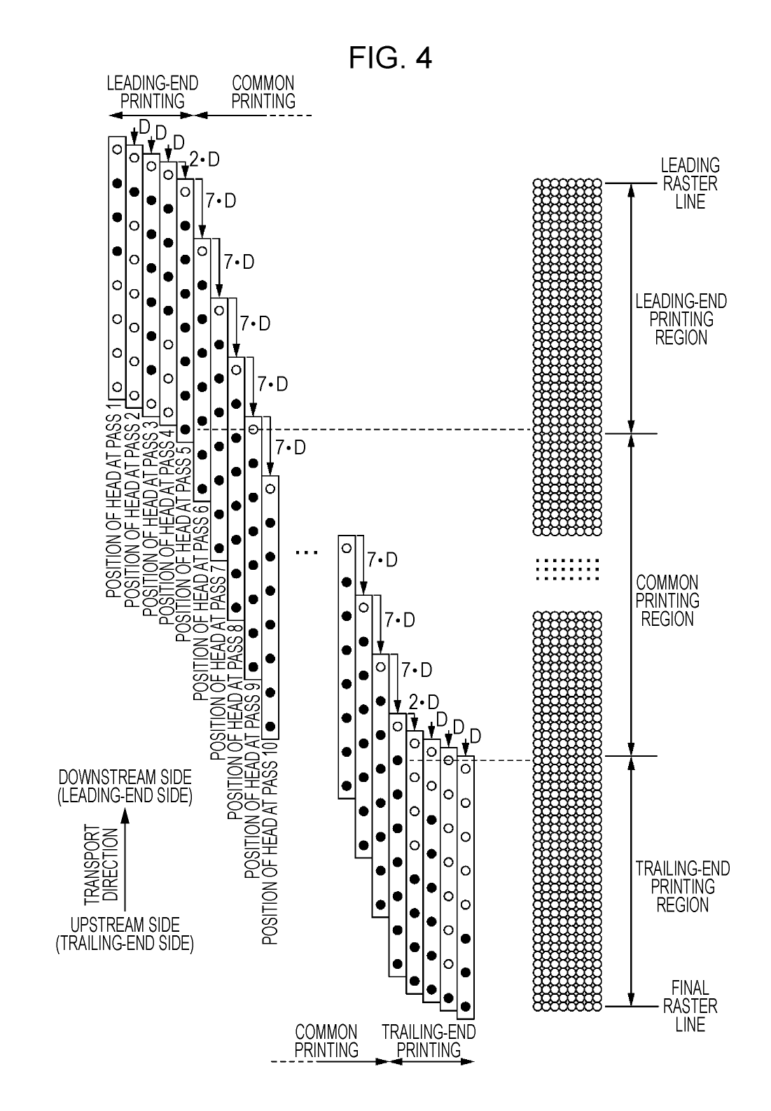

FIG. 5A is an explanatory view showing a case in which the dots are ideally formed. The fact in which the dots are ideally formed means that the ink droplets of specified amount are landed at a center portion of the pixel region to form the dots.

FIG. 5B is an explanatory view showing a case in which the unevenness in concentration occurs. The raster line formed in the second line region is formed under a bias towards the third line region side by the ink droplets ejected and flied on a skew from the nozzles. As a result, the second line region becomes thin, and the third line region becomes dense. Since the ink quantity of the ink droplets ejected in the fifth line region is smaller than a defined amount, the dots formed in the fifth line region become small. As a result, the fifth line region becomes thin. If the image constituted by arrays of different shading is macroscopically seen, the concentration unevenness of a stripped shape is visually recognized in the moving direction of the carriage.

FIG. 5C is an explanatory view showing a case in which the dots are formed in accordance with correction values (described below) used in this embodiment. In order to form thin image sections with respect to the line region which is easily visually recognized to be dense, the gradation value expressed by the pixel data corresponding to the line region is corrected. Further, in order to form dense image sections with respect to the line region which is easily visually recognized to be thin, the gradation value expressed by the pixel data corresponding to the line region is corrected. For example, as formation rates of the dots on the second and fifth line regions which are visually recognized to be dense are increased, a formation rate of the dots on the third line region which is visually recognized to be dense is lowered. In this way, it is possible to suppress the unevenness in concentration of the image.

Here, in FIG. 5B, the reason why the concentration of the image section formed in the third line region becomes dense is not by an influence of the nozzles which form the raster line in the third line region, but by an influence of the nozzles which form the raster line in the second neighboring line region. For this reason, in the case in which the nozzles forming the raster line in the third line region form the raster line in other line region, it is not always true that the image section formed in the line region becomes dense. In interlace printing shown in FIGS. 3 and 4, it is not always true that the line region adjacent to the line region allocated to a certain nozzles is the same nozzles every time.

That is, even in the image section formed by the same nozzles, there is a case in which the concentration is different, if the nozzles forming the neighboring image sections are different. In such a case, it is not possible to suppress the unevenness in concentration by the correction value merely corresponding to the nozzles. Consequently, the concentration unevenness correction value H is set for every line region (every pixel line data) in this embodiment.

### Regarding the Concentration Unevenness Correction Value H

Since the unevenness in concentration is caused by problems such as processing accuracy of the nozzles or like, the correction value H for every line region (every pixel line data) is calculated for every printer 1 at the time of fabrication of the printer 1 or the like. The printer 1 calculating the correction value H is connected to a scanner and a computer. The computer is installed with a printer driver for printing a test pattern (which will be described below) through the printer 1, and a correction value acquiring program for calculating the correction value H based on the reading data read by the scanner. The method of acquiring the correction value H will now be described.

### Printing of Test Pattern

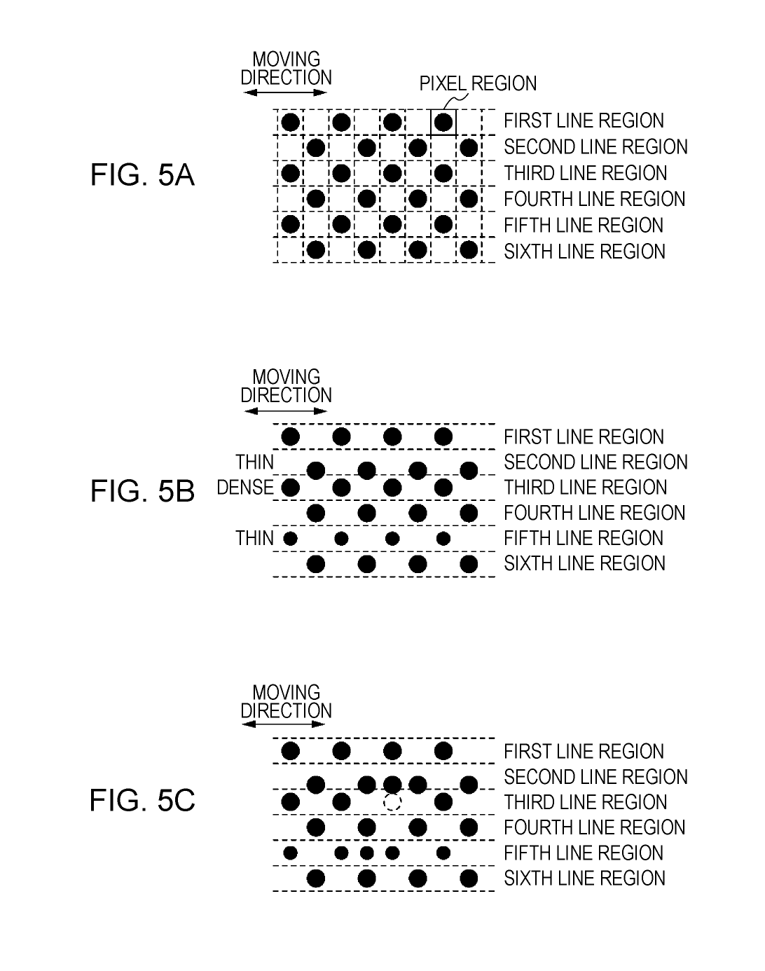

FIG. 6A is a view showing a test pattern, and FIG. 6B is a view showing a correction pattern. The test pattern is constituted by 4 correction patterns formed for every nozzle lines of different colors (cyan, magenta, yellow and black). The respective correction pattern is constituted by a strapped pattern having three kinds of concentration. Each of the respective strapped patterns is generated from the image data of constant gradation value. The gradation value for forming the strapped pattern is referred to as a command gradation value, in which a command gradation value of the strapped pattern of concentration 30% is expressed by Sa (76), a command gradation value of the strapped pattern of concentration 50% is expressed by Sb (128), and a command gradation value of the strapped pattern of concentration 70% is expressed by Sc (179). In this instance, the high gradation value indicates the dense concentration, and the low gradation value indicates the thin concentration.

Further, in interlace printing described above, the respective strapped pattern is constituted by 30 raster lines formed by leading-end printing, 56 raster lines formed by the common printing, and 30 raster lines formed by trailing-end printing. In other words, the strapped pattern is formed by 116 line regions in total.

### Acquisition of Read Gradation Value

Next, the read gradation values for every color and concentration are acquired by reading the test pattern with the scanner. Further, one pixel line data (a plurality of pixel data lined up in a direction corresponding to the moving direction) in the data read by the scanner corresponds to one line region (one raster line) in the correction pattern.

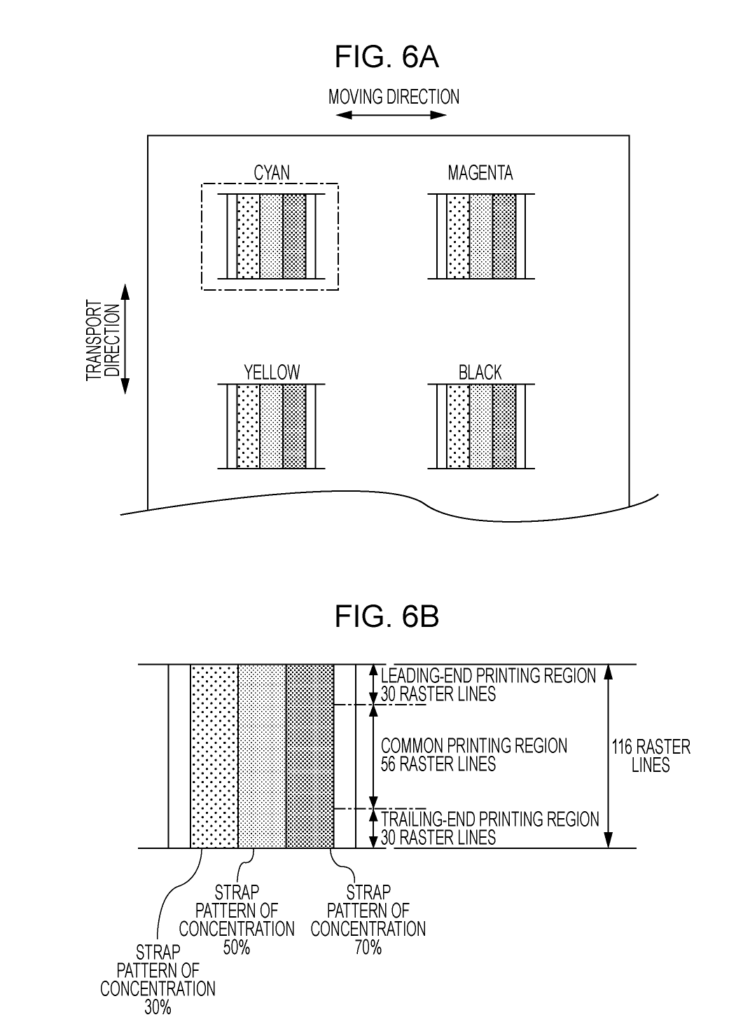

FIG. 7 is the result in which the cyan correction pattern is read by the scanner. The read data of cyan will now be described by way of example. After the pixel line data and the line region (the raster line) are corresponded one-to-one to each other, the concentration of the respective line regions is calculated for every strapped pattern. An average value of the read gradation values of the respective pixel data belonging to the pixel line data which corresponds one-to-one to a certain line region is set as the read gradation value of the line region. In the graph of FIG. 7, a transverse axis is referred to as an line region number, and a vertical axis is referred to as a read gradation value of the respective region.

Irrespective of the respective strapped patterns which is uniformly formed by each of the command gradation values, as shown in FIG. 7, a variation occurs in the read gradation values for every line region. For example, in the graph in FIG. 7, the read gradation value Cbi of the i-th line region is lower than the read gradation value of other line region, and the read gradation value Cbj of the j-th line region is higher the read gradation value of the other line region. That is, the i-th line region is visually recognized to be thin, and the j-th line region is visually recognized to be dense. The variation in the read gradation values of the respective line region is the unevenness in concentration of the print image.

### Calculation of Concentration Unevenness Correction Value H

In order to improve the evenness in concentration, the variation in the read gradation value for every line region is reduced. That is, the read gradation value of the respective line region is maintained in a constant value. Consequently, in the same command gradation value (e.g., Sb·concentration 50%), an average value Cbt of the read gradation value (Cb1 to Cb116) of the whole line region is set as a “target value Cbt”. In order to approach the read gradation value of the respective line region to the target value Cbt in the command gradation value Sb, the gradation value expressed by the pixel line data corresponding to the respective line region is corrected.

More specifically, in FIG. 7, the gradation value expressed by the pixel line data corresponding to the i-th line region having the read gradation value lower than the target value Cbt is corrected as a gradation value which is denser than the command gradation value Sb. Meanwhile, the gradation value expressed by the pixel line data corresponding to the j-th line region having the read gradation value higher than the target value Cbt is corrected as a gradation value which is thinner than the command gradation value Sb. In this way, in order to approach the concentration of the whole line region to a constant value for the same gradation value, a correction value H for correcting the gradation value of the pixel line data corresponding to the respective line region is calculated.

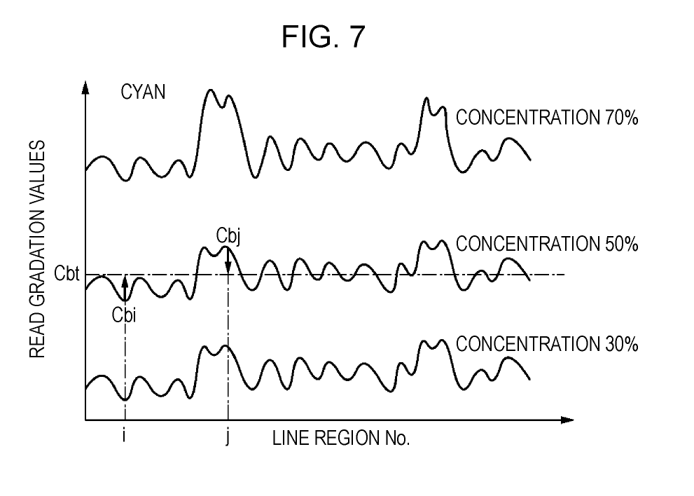

FIGS. 8A and 8B are views showing a concrete method for calculating the concentration unevenness correction value H. First, FIG. 8A shows the aspect in which the target command gradation value (e.g., Sbt) in the command gradation value (e.g., Sb) is calculated in the i-th line region having the read gradation value lower than the target value Cbt. A transverse axis indicates a gradation value, and a vertical axis indicates a read gradation value in the test pattern result. On the graph, the read gradation values (Cai, Cbi, and Cci) for the command gradation values (Sa, Sb, and Sc) are plotted. For example, the target command gradation value Sbt to express the i-th line region for the command gradation value Sb as the target value Cbt is calculated by the following equation (linear interpolation based on a straight line BC).

Sbt=Sb+{(Sc−Sb)×(Cbt−Cbi)/(Cci−Cbi)}

Similarly, as shown in FIG. 8B, in the j-th line region having the read gradation value higher than the target value Cbt, the target command gradation value Sbt to express the j-th line region for the command gradation value Sb as the target value Cbt is calculated by the following equation (linear interpolation based on a straight line AB).

Sbt=Sa+{(Sb−Sa)×(Cbt−Caj)/(Cbi−Caj)}

In this way, the target command gradation value Sbt of the respective line regions for the command gradation value Sb is calculated. Thus, the cyan correction value Hb for the command gradation value Sb of the respective line regions is calculated by the following equation. Similarly, the correction values for other command gradation values (Sa and Sc) and the correction values for other colors (yellow, magenta and black) are calculated.

Hb=(Sbt−Sb)/Sb

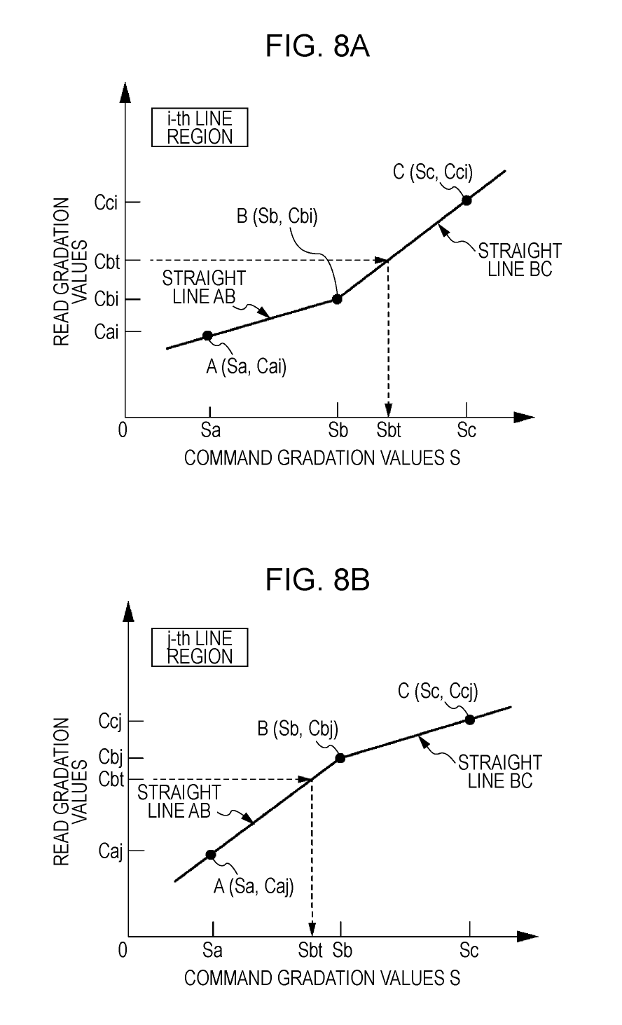

FIG. 9 is a view showing a correction value table for cyan of the common printing region in interlace printing. As described above, since there is the regularity for every 7 raster lines in the common printing region, 7 correction values for every command gradation value (Sa, Sb and Sc) in the common printing region is calculated. For example, the correction value for the command gradation value Sa of the first line region having the regularity is expressed as “Ha_1”. In this instance, since 56 raster lines are printed on the common printing region in the correction pattern (FIG. 6B), the correction value H may be calculated based on the average value of the read gradation value of 8 line regions in total at intervals of 7 line regions.

Such correction value tables are prepared for leading-end printing region and the trailing-end printing region (not shown). Further, each correction value tables is prepared for the common printing region, the leading-end printing region and the trailing-end printing region other color in case of other colors (yellow, magenta and black). In this way, the test pattern for calculating the correction value H is stored in the memory 13 of the printer 1. After that, the printer 1 is shipped to a user.

### Regarding the Concentration Correction Processing According to a Comparative Embodiment

A user installs the printer driver in the computer 60 connected to the printer 1 at the start time of using the printer 1. If then, the printer driver requests the printer 1 to transmit the correction value H stored in the memory 13 to the computer 60. The printer driver stores the correction value H transmitted from the printer 1 in the memory of the computer 60.

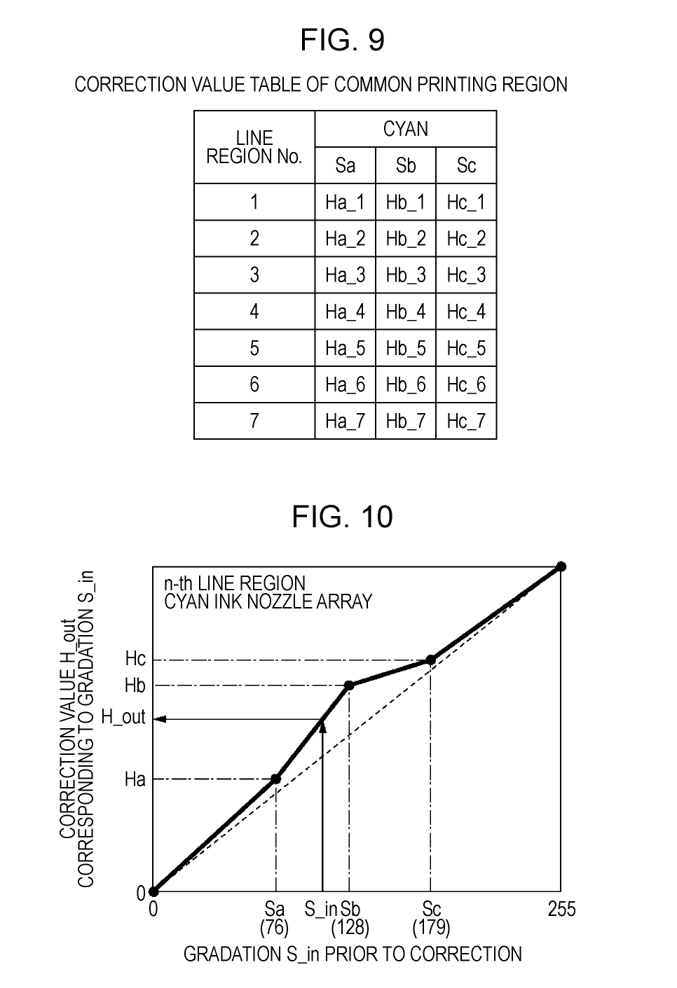

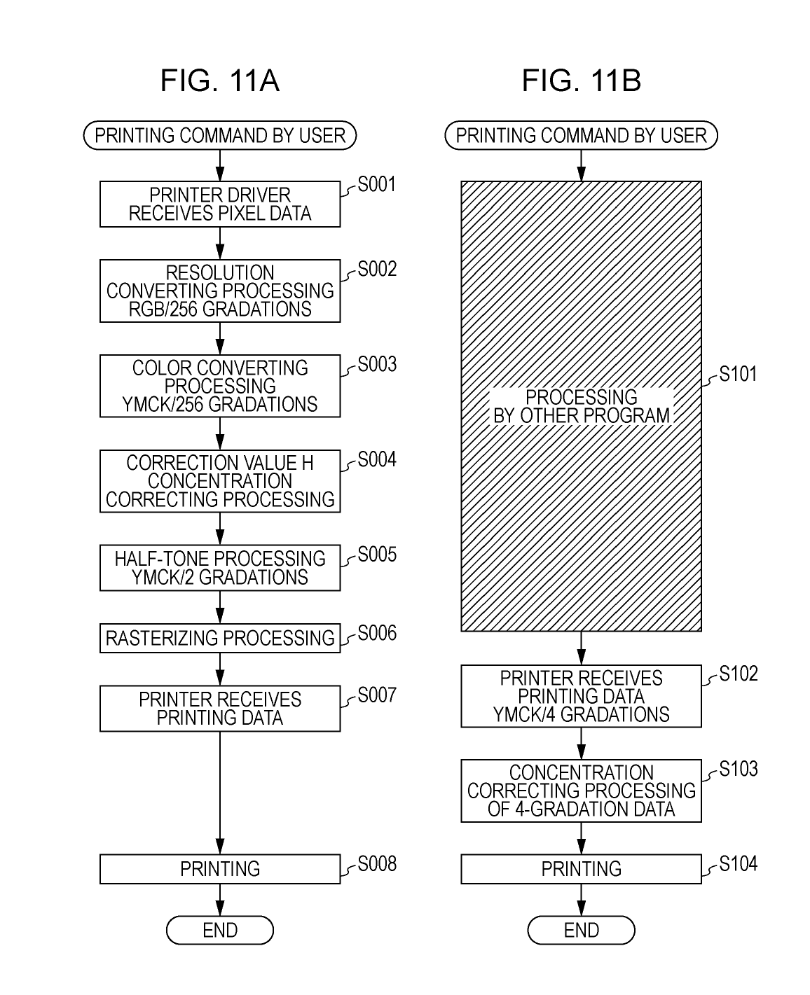

FIG. 10 is a view showing a shape of calculating the correction value H corresponding to the respective gradation values for the n-th line region of cyan. A transverse axis indicates a gradation value S_in prior to the correction, and a vertical axis indicates a correction value H_out corresponding to the gradation value S_in prior to the correction. FIG. 11A is a flowchart showing the concentration correction processing (printing processing) according to the comparative embodiment. As described above, if the printer driver receives a printing command from the user, it generates printing data in accordance with the flowchart in FIG. 11A, and transmits the printing data to the printer 1.

First, the printer driver receives the image data from various kinds of application software, as well as the printing command of the user (S001). The image data are converted into the resolution corresponding to the printing resolution (S002), and the color conversion is performed in accordance with colors YMCK of the ink provided in the printer 1 (S003).

The printer driver performs the concentration correction processing with respect to the data of 256 gradations of YMCK by using the correction value H (S004). That is, the gradation value (the gradation value S_in prior to the correction) of 256 gradations of each pixel data constituting the image data is corrected by the correction value H set for every color and line region corresponding to the pixel data.

If the gradation value S_in prior to the correction is equal to any one Sa, Sb, or Sc of the command gradation values, the correction values Ha, Hb and Hc stored in the memory of the computer 60 as the correction value H corresponding to the respective command gradation values can be used intact. For example, if the gradation value S_in prior to the correction is Sc, the gradation value S_out after the correction is obtained by the following equation.

S_out=Sc×(1+Hc)

If the gradation value S_in prior to the correction is different from the command gradation value, the correction value H_out according to the gradation value S_in prior to the correction is calculated. For example, as shown in FIG. 10, if the gradation value S_in prior to the correction is between the command gradation values Sa and Sb, the correction value H_out is calculated by the following equation according to the linear interpolation of the correction value Ha of the command gradation value Sa and the correction value Hb of the command gradation value Sb, and then the gradation value S_out after the correction is calculated.

H_out=Ha+{(Hb−Ha)×(S_in−Sa)/(Sb−Sa)}

S_out=S_in×(1+H_out)

In this instance, if the gradation value S_in prior to the correction is smaller than the command gradation value Sa, the correction value H_out is calculated by the linear interpolation of the minimum gradation value 0 and the command gradation value Sa, and if the gradation value S_in prior to the correction is larger than the command gradation value Sc, the correction value H_out is calculated by the linear interpolation of the maximum gradation value 255 and the command gradation value Sc.

In this way, the gradation value S_in expressed by pixel data of 256 gradations is corrected by the correction value H set for every color, line region corresponding to the pixel data and the gradation value. And thus, the gradation value S_in of the pixel data corresponding to the line region, of which the concentration is visually recognized to be thin, is corrected as the dense gradation value S_out, and the gradation value S_in of the pixel data corresponding to the line region, of which the concentration is visually recognized to be dense, is corrected as the thin gradation value S_out. As a result, it is possible to reduce the evenness in concentration occurring in the printed image.

The printer driver converts the pixel data (S_out) of 256 gradations after the correction into the pixel data of 4 gradations according to the kind of the dots which can be formed by the printer 1, by the half-tone processing (S005 in FIG. 11A). The printer 1 of this embodiment can form 3 kinds of dots (large dots, middle dots and small dots), and the 8-bit data of 256 gradations is converted into 2-bit data of 4 gradations (corresponding to the predetermined number of gradations) by the half-tone processing. For example, the pixel data expressing “large dot formation” is converted into “11”, the pixel data expressing “middle dot formation” is converted into “10”, the pixel data expressing “small dot formation” is converted into “01”, and the pixel data expressing “no dot exists” is converted into “00”. Next, the concrete method of the half-tone processing will be described.

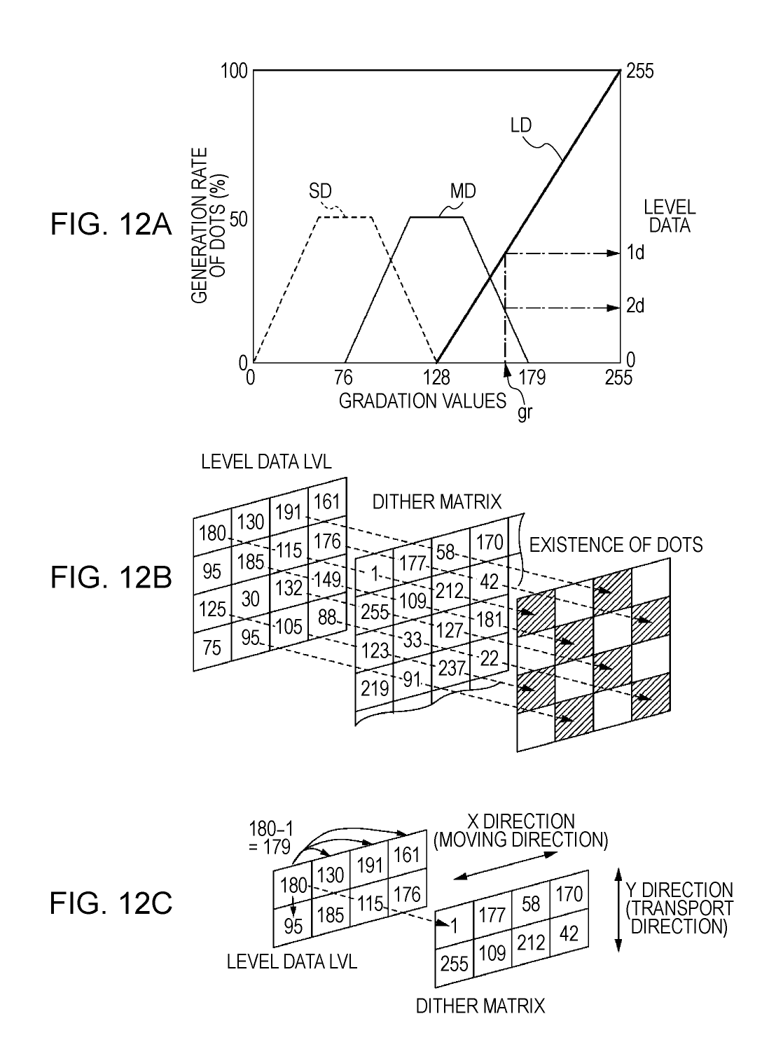

FIG. 12A is an explanatory view of a table of a formation rate of the dots. A transverse axis of a graph indicates gradation values (0 to 255), and a vertical axis indicates a generation rate of the dot (0 to 100%) at a left side thereof and indicates a level data at a right side thereof. FIG. 12B is a view showing a shape of ON/OFF judgment of the dot by a dither method. FIG. 12C is a view showing a shape of an error diffusion method.

The term “generation rate of the dot” means, when the same regions are reproduced according to the constant gradation value, a ratio of a pixel forming a dot among the pixels in the region. For example, in the case in which the gradation value of all the pixel data of 16×16 pixels is a constant value, when n dots are formed in the 16×16 pixels, the formation rate of the dots in the gradation value is expressed by {n/(16×16)}×100(%)}. A profile SD indicated by a dotted line in the figure expresses the formation rate of the small dots, a profile MD indicated by a thin solid line in the figure expresses the formation rate of the middle dots, and a profile LD indicated by a thick solid line in the figure expresses the formation rate of the large dots. Further, the term “level data” means data of which the formation rate of the dots is expressed by 256 steps of 0 to 255 values.

First, the printer driver sets large-dot level data in accordance with the gradation value of certain pixel data. For example, if the gradation value of certain pixel data is gr shown in the figure, the large-dot level data are set as 1d based on the profile LD. It is judged whether the large-dot level data are larger than a threshold value set to each pixel of a dither matrix shown in FIG. 12B. The threshold value is set as different values for each pixel of the dither matrix. In this embodiment, a matrix in which the 16×16 pixel blocks are expressed by values of 0 to 255 is used.

For example, for the pixel on the left side of FIG. 12B, the large-dot level data are set as “180”. The threshold value on the dither matrix corresponding to the pixel is “1”. The printer driver compares the large-dot level data “180” with the threshold value “1”. In this instance, it is judged that the large-dot level data are larger than the threshold value, and the pixel data of the pixel on the left side is converted into “11 (formation of large dots)”, and then the processing of the pixel data is completed. In FIG. 12B, the pixels, in which the dots are formed, are indicated by an oblique line.

Meanwhile, if the large-dot level data are equal to or less than the threshold value, the printer driver sets middle-dot level data. In the pixel data of a gradation value gr, the middle-dot level data are set as 2d based on the profile MD. If the middle-dot level data are larger than the threshold value, the pixel data of the pixel is converted into “10 (formation of middle dots)”, and then the processing of the pixel data is completed. In this instance, the threshold value of the dither matrix is set for every kind of the dot.

Then, if the middle-dot level data are equal to or less than the threshold value, it is judged whether the small-dot level data are larger than the threshold value or not. If the small-dot level data are larger than the threshold value, the pixel data of the pixel is converted into “01 (formation of small dots)”, and if the small-dot level data are equal to or less than the threshold value, the pixel data of the pixel is converted into “00 (no dot exists)”. Then, the processing of the pixel data is completed. In this way, the pixel data of 256 gradations is converted into pixel data of 4 gradations. In this instance, since the level data of small dots is 0 in the gradation value gr in FIG. 12A, the small dot is not formed.

Further, at the time of half-tone processing, as shown in FIG. 12C, the embodiment applies the error diffusion method. In the error diffusion method, a difference (error) between the level data of the pixel which judges the existence of the dot formation and the threshold value corresponding to the pixel is distributed (diffused) to the non-processed pixel. In the non-processed pixel which is distributed with the error, the total value of the level data of the pixel and the error is compared with the threshold value corresponding to the dither matrix to judge the existence of the dot formation.

For example, in FIG. 12C, the printer driver compares the level data of the pixel on the left side with the threshold value of the dither matrix, and judges that the dots are formed on the pixel on the left side. After the judgment, the printer driver calculates the error “179 (=180−1)” between the level data and the threshold value. The error is distributed to the pixels arranged in parallel with the pixel on the left side in the X direction or the pixels arranged in parallel with the pixel on the left side in the Y direction. In this instance, in the case in which the threshold value is larger than the level data, minus error is distributed to the neighboring pixel. In this way, it is possible to reduce the local concentration error, thereby smoothing the concentration of the whole image.

In particular, it is preferable that the error diffusion method is performed in the case in which the gradation value is corrected by the correction value H. A correction amount in which the gradation value of each pixel data is increased or decreased by the correction value H is minute. For example, in order to make the line region dense, even though the gradation value of the pixel data belonging to the line region is increased by the correction value H and thus the value of the level data is increased, there is a situation that the number of the dots or the size of the dot is not increased in accordance with the threshold value of the dither matrix. For this reason, the value of the level data is highly corrected by correcting highly the gradation value of a certain pixel, but, even though the dot is not formed in the pixel by the relationship of the threshold value, since the error of the threshold value and the level data is distributed to the neighboring pixels, new dots are formed in any one of the non-processed pixels in the course of integrating the error. Therefore, the line region can be densely printed. By contrast, in the case in which the gradation value of a certain pixel is lowly corrected, a dot may be not formed in a certain pixel by distributing the minus error just as much as the corrected amount to the pixel.

For this reason, in order to reflect the error (the error between the level data and the threshold value) by the gradation value, which is increased or decreased by the correction value H, on the pixel belonging to the same line region, the error of certain pixel data may be distributed not to the pixel data which are lined up with the pixel data in the Y direction (corresponding to the transport direction), but to the pixel data which are lined-up with the pixel data in the X direction (corresponding to the moving direction), that is, the pixel data belonging to the same line region. For example, in FIG. 12C, the error “179” of the pixel on the left side is distributed to three pixel data belonging to the same line region, and one pixel data lined up in the Y direction. Further, when the error is distributed to the non-processed pixel, the error may be uniformly distributed to the pixels, or may be largely distributed to the pixel as the pixel is closer to the pixel in which the error occurs, by changing a weight. As such, according to the half-tone processing by the error diffusion method, the generation rate of the dots can be surely changed based on the correction value H, thereby solving the unevenness in concentration.

The pixel data of the low number of gradations which is half-tone processed is subjected to rasterizing processing (S006), as shown in FIG. 11A, and then is transmitted to the printer 1 as the printing data, together with command data. If the printer 1 receives the printing data (S007), the printing is performed on the basis of the printing data (S008).

Summarizing the above, in the concentration correction processing of the comparative embodiment, in the printing system in which the computer 60 installed with the printer driver is connected to the printer 1, the printer driver corrects the pixel data (the gradation value) of the high number of gradations (256 gradations) prior to the half-tone processing according to the correction value H, and then performs the half-tone processing, so that the corrected pixel data of the high number of gradations is converted into the pixel data of the low number of gradations (4 gradations). The printer 1 performs the printing based on the pixel data of low gradations. As a result, it is possible to reduce the unevenness in concentration of the printed image.

Regarding the Concentration Correction Processing According to this Embodiment

FIG. 11B is a flowchart showing the concentration correction processing (printing process) of this embodiment. In the concentration correction processing of the comparative embodiment, the printer driver corrects the pixel data prior to the half-tone processing according to the correction value H. However, it is not limited such that the printing data are transmitted to the printer 1 by the printer driver corresponding to the printer 1, and there is a case in which the printing data which is half-tone processed is transmitted to the printer 1 by application programs different from the printer driver (e.g., a program of a product manufactured by other company which is referred to as other program).

Similar to the printer driver, in other programs, in step S101 (a block portion indicated by an oblique line) in FIG. 11B, the image data formed by the user is subjected to the resolution conversion and the color conversion in line with the printing resolution, and then is half-tone processed. The printer drive obtains the correction value H from the memory 13 of the printer 1, corrects the pixel data of 256 gradations according to the correction value H, and then performs the half-tone processing. However, in other program, the pixel data of 256 gradations is not corrected, but is half-tone processed. That is, the printing data transmitted to the printer 1 from other program different from the printer driver is pixel data of 4 gradations which is not subjected to the concentration correction processing. For example, if the printer 1 performs the printing using the printing data intact which is transmitted from other program, the unevenness in concentration occurs on the printed image.

For this reason, an object of this embodiment is to suppress the unevenness in concentration on the printed image by performing the concentration correction processing to the pixel data of 4 gradations (corresponding to the pixel data of the predetermined number of gradations) transmitted from other program different from the printer driver.

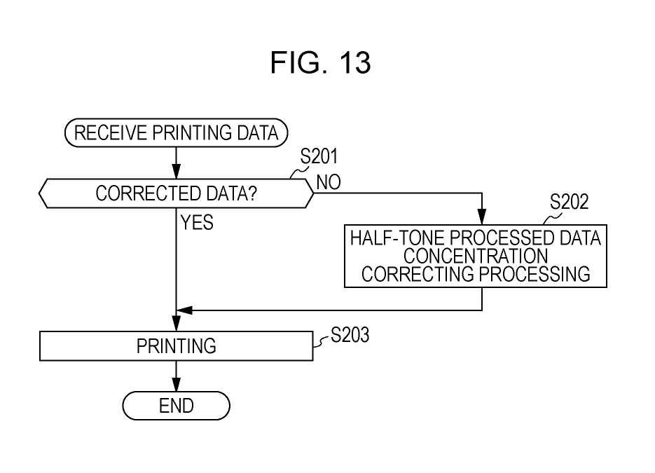

FIG. 13 is a flowchart showing that an identification unit 16 processes the printing data transmitted from the printer 1. The identification unit 16 (FIG. 1) provided in the controller 10 of the printer 1 judges whether the printing data transmitted to the printer 1 is the post-correction data (the printing data which is subjected to the concentration correction processing by the correction value H) or the pre-correction data (the printing data which are not subjected to the concentration correction processing by the correction value H). If the identification unit 16 judges that the transmitted printing data are the post-correction data (Yes at S201), the printer 1 performs the printing based on the printing data (S008 in FIG. 11A).

Meanwhile, the identification unit 16 judges that the transmitted printing data are the pre-correction data (No at S201), the printing data are subjected to the concentration correction processing (S103 in FIG. 11B), and then the printing is performed (S104). In this instance, the pre-correction data is subjected to the concentration correction processing by the concentration correction processing unit 15 in the controller 10 of the printer 1. Further, it is not limited to the judgment whether it is the post-correction data, and it is identified whether it is the data transmitted from the printer driver corresponding to the printer 1 or the data transmitted from other program, in which the data transmitted from the printer driver may be used intact for the printing and the data transmitted from other program may be subjected to the concentration correction processing. Next, the method of correcting the concentration of the pixel data of 4 gradations that is half-tone processed will be described.

### Concentration Correction Processing

### Example 1

In Example 1, the process of correcting concentration of pixel data of 4 gradations that is half-tone processed by other program is performed using a correction value H stored in the memory 13 of the printer 1. However, this correction value H (hereinafter referred to as “high gradation correction value H” that is a correction value corresponding to a high gradation value) is a correction value H that is used for the pixel data of 256 gradations when the printer driver performs the concentration correcting process (S004 in FIG. 11A). Even if the correction value H is to correct the pixel data of 256 gradations, the correction value for correcting the shading of the line regions that corresponds to the pixel data is not changed.

For example, in the case in which the pixel line data (i.e. a plurality of pixel data lined up in a direction corresponding to the moving direction on the data) of 256 gradations corresponding to a certain line region is corrected to a dense gradation value by the high gradation correction value H, the pixel data of 4 gradations corresponding to the certain line region is corrected so that the certain line region is densely visually recognized. By contrast, in the case in which the pixel line data of 256 gradations corresponding to a certain line region is corrected to a thin gradation value by the high gradation correction value H, the pixel data of 4 gradations corresponding to the certain line region is corrected so that the certain line region is thinly visually recognized. That is, it can be judged by the high gradation correction value H corresponding to the certain line region whether the pixel data of 4 gradations corresponding to the certain line region is to be densely corrected or thinly corrected. In this case, the high gradation correction value H is represented by the following equation. Here, St denotes a target read gradation value, and S denotes an actual read gradation value.

H=(St−S)/S

Accordingly, if the high gradation correction value H of a certain line region presents a plus value, the line region is densely corrected, and if the high gradation correction value H of a certain line region presents a minus value, the line region is thinly corrected.

The pixel data of 4 gradations indicates the existence/nonexistence of dot formation and the size of the dot. Also, the high gradation correction value H indicates the ratio of a difference between the target concentration St and the actual concentration S to the actual concentration S. Accordingly, in Example 1, in the case of correcting the pixel data of 4 gradations by the high gradation correction value H, the correction is performed with respect to the pixel data the number of which corresponds to the ratio of the high gradation correction value H among the pixel data belonging to the pixel data of 4 gradations corresponding to the certain line region. Specifically, the number of dots to be generated or the dot size is changed. By doing this, it is possible to change the degree of concentration correction of the respective line region in accordance with the correction value H of the respective line regions.

For example, if the correction value H corresponding to one side line region is larger than the correction value H corresponding to the other side line region even in the line regions in which the same concentration becomes dense, the degree of dense concentration in one side line region becomes higher than that in the other side line region. Accordingly, by correcting the pixel data the number of which corresponds to the ratio of the high gradation correction value H, the number of correction of pixel data corresponding to one side line region becomes larger than that corresponding to the other side line region, and thus the number of dots which are newly generated and the number of dots of which the size becomes large can be increased to heighten the degree of dense concentration.

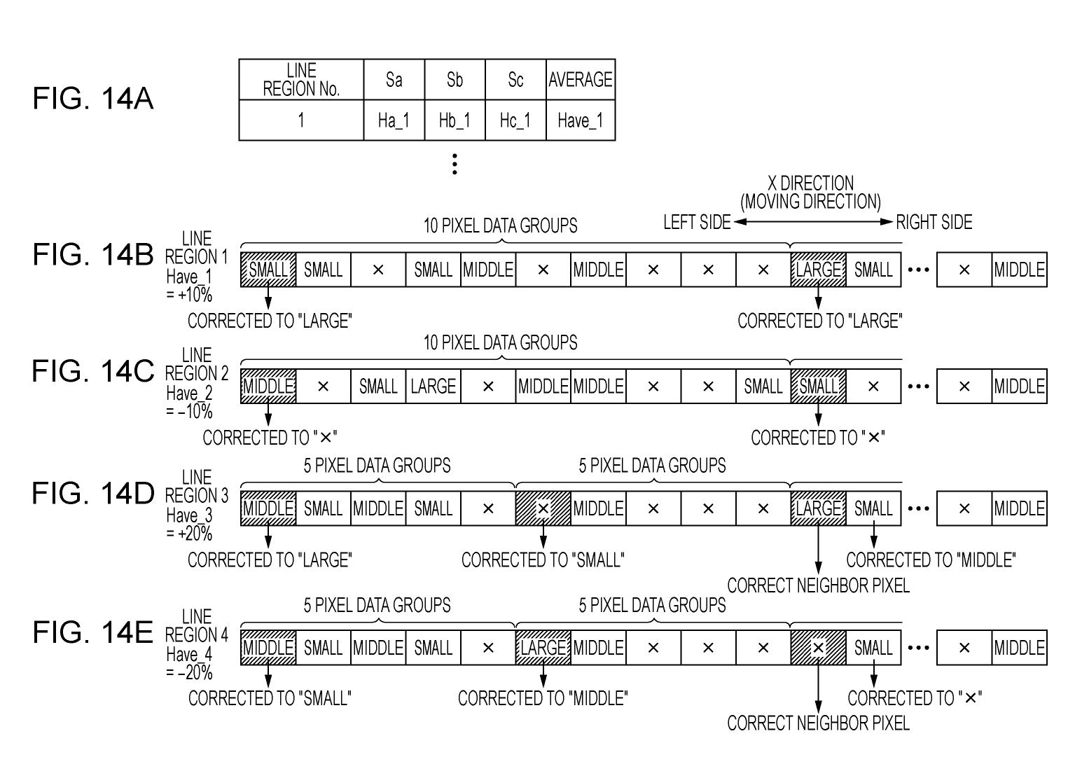

FIG. 14A, in Example 1, is a view showing a correction value table stored in the memory 13 of the printer 1. In the memory 13 of the printer 1, as illustrated in FIG. 9, high gradation correction values H are stored by colors, by line regions, and by command gradation values (Sa, Sb, and Sc). Also, by linear interpolation of the command gradation values, the correction values H corresponding to the respective gradation values (0 to 255) of 256 gradations can be calculated.

The high gradation correction values H divided by colors and by line regions can be used for the pixel data of 4 gradations. However, it is difficult to selectively use the correction values H according to the respective gradation values of 256 gradations with respect to the pixel data of 4 gradations. Accordingly, in Example 1, an average value Have of the respective correction values (Ha, Hb, and Hc) of three command gradation values (Sa, Sb, and Sc) is stored in the memory 13 of the printer 1, as shown in FIG. 14A, and based on this average value Have of the high gradation correction values H, the pixel data of 4 gradations is corrected. In this case, the average value Have of the high gradation correction values is not limited to be stored in the memory 13, but may be calculated from the three correction values when the concentration correction processing unit 15 performs the concentration correction.

FIGS. 14B and 14C are views showing the shape of the pixel line data corresponding to one line region that is corrected by the high gradation correction values H. Hereinafter, the concrete method of correcting pixel data of 4 gradations by the average Have of the high gradation correction values will be described. One grid as shown in FIGS. 14B and 14C corresponds to a pixel. A pixel forming a large dot is indicated as “large”, a pixel forming a middle dot is indicated as “middle”, and a pixel forming a small dot is indicated as “small”. A pixel forming no dot is indicated as “x”.

For example, as shown in FIG. 14B, it is assumed that an average high-gradation correction value Have_1 of an line region 1 is “+10%”. In this case, the concentration correction processing unit 15 corrects the pixel line data corresponding to the line region 1 in a manner that it corrects one pixel data to “large dot formation” for every 10 pixel data in order from the pixel data on the left side of an X direction (i.e. a direction corresponding to the moving direction on the data).

Specifically, the concentration correction processing unit 15, when it corrects the pixel data of 4 gradations corresponding to the line region 1, acquires the average high-gradation correction value “+10%” that corresponds to the line region 1 with reference to the correction value table (See FIG. 14A) stored in the memory 13 of the printer 1. Thereafter, the concentration correction processing unit converts the pixel data on the leftmost side of the X direction among the pixel line data corresponding to the line region 1 from “small dot formation” to “large dot formation”. In the same manner, the concentration correction processing unit 15 converts 11^{th} pixel data, 21^{st} pixel data, . . . and every 10^{th} pixel data on the left side of the X direction into “large dot formation”. By doing this, as indicated by the average high-gradation correction value Have_1 (+10%) corresponding to the line region 1, the line region 1 can be printed at dense concentration.

In this instance, the concentration correction processing unit 15 converts the pixel data into “large dot formation” regardless of what the every 10^{th} pre-correction pixel data indicates. Accordingly, if the 11^{th} pixel data from the left side of the X direction originally indicates “large dot formation”, the dot size may not increase. However, although a certain every 10^{th} pixel data are not changed to increase the dot size, other every 10^{th} pixel data, even if the dot is not originally formed, may form large dots, and thus the line region 1 can be densely printed. As described above, since the concentration correction processing unit 15 converts the every 10^{th} pixel data into “large dot formation” regardless of what the every 10^{th} pixel data indicates, the concentration correction processing time can be shortened.

Also, as shown in FIG. 14C, it is assumed that an average high-gradation correction value Have_1 of a line region 2 is “−10%”. In this case, the concentration correction processing unit 15 corrects the pixel line data corresponding to the line region 2 in a manner that it corrects one pixel data to “no dot exists” for every 10 pixel data in order from the pixel data on the left side of an X direction. In this case, the concentration correction processing unit 15 converts the pixel data into “no dot exists” regardless of what the every 10^{th} pre-correction pixel data indicates. As shown in the drawing, the concentration correction processing unit 15 converts the pixel data on the leftmost side of the line region 2 from “middle dot formation” to “no dot exists”, and converts 11^{th} pixel data on the left side of the line regions 2 from “small dot formation” to “no dot exists”. By doing this, as indicated by the average high-gradation correction value Have_2 (−10%) corresponding to the line region 2, the line region 2 can be printed at thin concentration.

As described above, if the concentration correction processing unit 15 receives the print data from another program, it corrects a plurality of pixel line data lined up in the Y direction (i.e. a direction corresponding to the transporting direction on the data) in the order based on the average high-gradation correction value Have corresponding to the respective pixel line data, as shown in FIG. 14B or 14C.

FIGS. 14D and 14E are views showing a modified example of correcting the pixel line data of 4 gradations by an average high-gradation correction value Have. Referring to FIGS. 14B and 14C as described above, in the case of densely correcting the pixel data, the pixel data are converted into “large dot formation”, and in the case of thinly correcting the pixel data, the pixel data are converted into “no dot exists”, regardless of the pre-correction data of the pixel data that is corrected according to the average high-gradation correction value Have. However, the correction of the pixel data is not limited thereto, and the data to be converted may differ in accordance with the data indicated by the pixel data to be corrected before the correction. For example, in the case of correcting the pixel data at dense concentration, the pixel data are corrected so that a dot having a larger size than the dot size indicated by the pre-correction pixel data by 1 is formed. By contrast, in the case of correcting the pixel data at thin concentration, the pixel data are corrected so that a dot having a smaller size than the dot size indicated by the pre-correction pixel data is formed.

In FIG. 14D, since the average high-gradation correction value Have corresponding to a line region 3 is “+20%”, the pixel data for every 5 pixel data among the pixel line data corresponding to the line region 3 is corrected. Since the pixel data on the leftmost side in the X direction among a plurality of pixel data that belong to the pixel line data corresponding to the line region 3 indicates “middle dot formation” before the correction, the concentration correction processing unit 15 converts the corresponding pixel data into “large dot formation”. In the same manner, since the 6^{th} pre-correction pixel data on the left indicates “no dot exists”, the concentration correction processing unit 15 corrects the corresponding pixel data pixel data to “small dot formation”. As described above, if the pre-correction pixel data indicates “no dot exists”, the concentration correction processing unit 15 converts the corresponding pixel data into “small dot formation”, and if the pre-correction pixel data indicates “small dot formation”, the concentration correction processing unit 15 converts the corresponding pixel data into “middle dot formation”. If the pre-correction pixel data indicates “middle dot formation”, the concentration correction processing unit 15 converts the corresponding pixel data into “large dot formation”. By doing this, the line region can be printed at dense concentration as indicated by the high gradation correction value H (i.e. the correction value corresponding to dense concentration) corresponding to the line region.

However, if the pre-correction pixel data indicates “large dot formation”, it is scarcely possible to enlarge the dot size above the level. Since the pixel data to be corrected is converted into “large dot formation” regardless of the data indicated by the pixel data to be corrected before the correction, as shown in FIGS. 14B and 14C, the dot size is not greatly corrected in the case in which the pre-correction pixel data indicates “large dot formation”.

However, the correction of the pixel data is not limited thereto, and in the case in which the pre-correction pixel data indicates “large dot formation”, other pixel data neighboring the pixel data to be corrected may be corrected. Since the 11^{th} pixel data on the left in FIG. 14D indicates “large dot formation”, the concentration correction processing unit 15 converts the 12^{th} pixel data indicating “small dot formation” into “middle dot formation”. By doing this, the line region can be certainly printed at dense concentration. Also, the pixel data to be corrected is not limited to the neighboring pixel data, and in the case in which the pixel data to be corrected indicates “large dot formation”, any pixel data of a pixel data group for every 5 pixel data (e.g. the 11^{th} to 15^{th} pixel data) may be corrected.

In the same manner, since the average high-gradation correction value Have corresponding to an line region 4, as shown in FIG. 14E, is “−20%”, the pixel data for every 5 pixel data among the pixel line data corresponding to the line region 4 is corrected. For example, since the pixel data on the leftmost side of the X direction among the pixel line data corresponding to the line region 4 indicates “middle dot formation” before the correction, the concentration correction processing unit converts the corresponding pixel data into “small dot formation”. In the same manner, since the 6^{th} pre-correction pixel data on the left indicates “large dot formation”, the concentration correction processing unit converts the corresponding pixel data pixel data into “middle dot formation”.

As described above, in the case of thinly correcting the line region, if the pre-correction pixel data indicates “large dot formation”, the concentration correction processing unit 15 converts the corresponding pixel data into “middle dot formation”, and if the pre-correction pixel data indicates “middle dot formation”, the concentration correction processing unit 15 converts the corresponding pixel data into “small dot formation”. If the pre-correction pixel data indicates “small dot formation”, the concentration correction processing unit 15 converts the corresponding pixel data into “no dot exists”. By doing this, the line region can be printed at thin concentration as indicated by the high gradation correction value H (i.e. the correction value corresponding to thin concentration) corresponding to the line region. Also, if the pixel data to be corrected indicates “no dot exists” before the correction, the concentration correction processing unit 15 may correct other neighboring pixel data. For example, since the 11^{th} pixel data in FIG. 14E indicates “no dot exists”, the neighboring 12^{th} pixel data may be converted from “small dot formation” to “no dot exists”.

Summarizing the above, in Example 1, in order to apply the high gradation correction value H stored in the memory 13 of the printer 1 to the pixel data of 4 gradations that is half-tone processed, the pixel data, the number of which corresponds to the high gradation correction value H of the corresponding line region among the plurality of pixel data that belong to the pixel line data corresponding to a certain line region, is corrected. In the case of densely correct the concentration of the line region, a new dot may be formed in the pixel data to be corrected, or the size of the dot to be formed may become large. By contrast, in the case of thinly correct the concentration of the line region, the dot, which should have been formed in the pixel data to be corrected, may be not formed, or the dot size may become small. By doing this, the concentration correction can be performed even with respect to the half-tone processed pixel data of 4 gradations received from another program, and thus the unevenness in concentration of a printed image can be lowered.

In FIGS. 14D and 14E, the dot size of the pixel data is increased or decreased by one step in comparison to the dot indicated by the pre-correction pixel data, but the adjustment of the dot size is not limited thereto. For example, in the same manner as the correction of the pixel data indicating “small dot formation” to “large dot formation”, the dot size may be corrected by two steps. Also, the correction of the pixel data is not limited to the correction of the pixel data of the number which corresponds to the high gradation correction value H, among the pixel line data corresponding to one line region, but the pixel data, the number of which corresponding the high gradation correction value H among the pixel data subject to dot formation, may be corrected as the pixel data corresponding to one line region. Also, the use of the correction value H is not limited to the use of the high gradation correction value H stored in the memory 13 of the printer 1, but a correction value of other 4 gradations that is different from the high gradation correction value H may be set and stored in the memory 13 of the printer 1. For example, the pixel data, the number of which corresponds to the correction value of 4 gradations among the plurality of pixel data belonging to the pixel line data corresponding to one line region, may be corrected.

In the case in which the concentration correction process of the pixel data of 4 gradations is performed by the concentration correction processing unit 15 in the controller 10 of the printer 1, the controller 10 corresponds to a control unit, and the printer 1 corresponds to a fluid ejecting apparatus. However, the implementation of the controller and the printer 1 is not limited thereto, but the printer driver may perform the corresponding processes. That is, in the case in which the printer 1 receives the print data from another program, the printer 1 may send the print data to the printer driver, and the printer driver may return the print data of which the concentration correction has been performed to the printer 1. In this case, a computer 60 in which the printer driver is installed and the controller 10 of the printer 1 correspond to the control unit, and a printing system connected to the printer 1 and the computer 60 corresponds to the fluid ejecting apparatus.

### Concentration Correction Processing

### Example 2

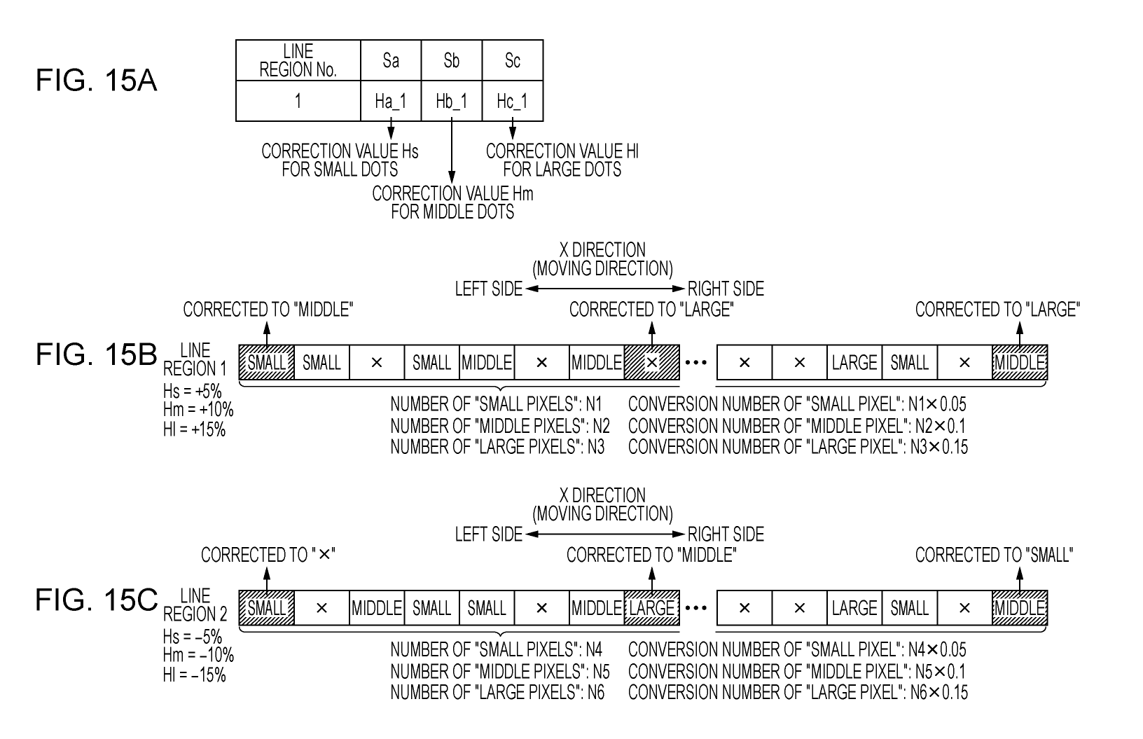

FIG. 15A is a view showing the high gradation correction value H used in Example 2, and FIG. 15B and FIG. 15C are views showing a shape of correcting the pixel data of 4 gradations according to Example 2. As known from the table on the formation rate of the dots in FIG. 12A, the dots forming the image (an image of low gradation value) of low concentration has a lot of small dots, the dots forming the image of intermediate concentration has a lot of middle dots, and the dots forming the image (an image of high gradation value) of high concentration has a lot of large dots.

In particular, according to the table on the formation rate of the dots in this embodiment, the strapped pattern (FIG. 6B) of concentration 30% formed by the command gradation value Sa (first gradation value) is formed only by small dots (first dots), the strapped pattern of concentration 50% formed by the command gradation value Sb (second gradation value) is formed only by middle dots (second dots), and the strapped pattern of concentration 70% formed by the command gradation value Sc (third gradation value) is formed only by large dots. For this reason, the correction value Ha corresponding to the command gradation value Sa is a correction value which is suitable for correcting the concentration of the image formed by a lot of small dots, the correction value Hb corresponding to the command gradation value Sb is a correction value which is suitable for correcting the concentration of the image formed by a lot of middle dots, and the correction value Hc corresponding to the command gradation value Sc is a correction value which is suitable for correcting the concentration of the image formed by a lot of large dots.

Consequently, in Example 2, the correction value Ha corresponding to the command gradation value Sa (76) of high concentration is set as “a correction value Hs for small dot (e.g., corresponding to the first correction value)”, the correction value Hb corresponding to the command gradation value Sb (128) of middle concentration is set as “a correction value Hm for middle dots (e.g., corresponding to the second correction value)”, and the correction value Hc corresponding to the command gradation value Sc (179) of high concentration is set as “a correction value Hl for large dots”. In the pixel data belonging to the pixel line data corresponding to one line region, among the pixel data forming the dots of each size, the number of pixel data corresponding to the correction values Hs, Hm and Hl of a dot of each size is corrected. Next, the concrete processing of the concentration correction processing unit 15 will be described.

FIG. 15B is a view showing a shape of correcting the pixel line data corresponding to the line region 1. The correction value corresponding to the line region 1 is set as a correction value for making the line region 1 dense. More specifically, the correction value Hs for small dots is set as “+5%”, the correction value Hm for middle dots is set as “+10%”, and the correction value Hl for large dots is set as “+15%”. Among pixel line data corresponding to the line region 1, the concentration correction processing unit 15 calculates the number (N1) of the pixels in which the small dots are formed, the number (N2) of the pixels in which the middle dots are formed, and the number (N3) of the pixels in which the large dots are formed.

The concentration correction processing unit 15 converts the number (N1×0.05) of the pixel data corresponding to the correction values Hs for small dots among the pixel data forming the small dots into the “middle dot formation”, and converts the number (N2×0.1) of the pixel data corresponding to the correction values Hm for middle dots among the pixel data forming the middle dots into the “large dot formation”. Since it is difficult to change the dots to be formed larger than the large dots in the pixel data forming large dots, new large dots are formed in the pixel in which no dot is formed. In this instance, it is not limited to the large dots, and the small dots or middle dots may be formed. That is, the concentration correction processing unit 15 converts the number of the pixel data (N3×0.15) corresponding to the correction value Hl for the large dot among the pixel data forming the large dots into “large dot formation”. In this instance, the pixel data to be corrected is pixel data which are lined up in a balanced manner in the X direction.

Further, in FIG. 15B, there are pixel data belonging to the line region 1 from “pixel in which no dot exists” to “large dot formation pixel”, for illustration. However, as can be known from the table on the formation rate of the dots in FIG. 12A, the kinds of the dots to be formed according to the gradation value (the concentration) are different, in fact. For this reason, a lot of small dots are formed in the line region of thin concentration, a lot of middle dots are formed in the line region of intermediate concentration, and a lot of large dots are formed in the line region of dense concentration.

In the high gradation value H (FIG. 10) of the printer 1 according to the embodiment, as the concentration becomes dense, the correction value H is increased (Hs<Hm<Hl), it is necessary to increase the dot size of a lot of pixel data or generate new large dots. That is, it is necessary that as the line region has thinner concentration, the correction amount is lower, and as the line region has denser concentration, the correction amount is higher. According to the concentration correction processing in Example 2, since the number of the pixels forming small dots is many in the pixel line data corresponding to the line region of thin concentration, the number of the pixel data to be corrected is small by the small correction value Hs, so that correction amount can be reduced. By contrast, since the number of the pixels forming large dots is many in the pixel line data corresponding to the line region of dense concentration, the number of the pixel data to be corrected can be increased by the large correction value Hl.

Similarly, FIG. 15C is a view showing a shape of correcting the line region 2 to be thin. Similar to the case of correcting the line region to be thin, the concentration correction processing unit 15 calculates the number (N4) of the pixels forming the small dots, the number (N5) of the pixels forming the middle dots, and the number (N6) of the pixels forming the large dots. Among the pixel forming the small dots, the number of the pixel data (N4×0.05) corresponding to the correction value “−5%” for small dot is converted into “no dot exists”. Among the pixel forming the middle dots, the number of the pixel data (N5×0.1) corresponding to the correction value “−10%” for middle dot is converted into “small dot formation”. Among the pixel forming the large dots, the number of the pixel data (N6×0.15) corresponding to the correction value “−15%” for large dot is converted into “middle dot formation”. As a result, it is possible to correct the line region 2 to be thin.

In Example 2, the correction value Ha of the thin command gradation value Sa is set as the correction value Hs for small dot, and in the case of including a lot of pixel data forming the small dots to make the concentration of the line region thin, it is possible to correct the number of the pixel data based on the correction value Ha (=Hs) for thin concentration. The correction value Hb of the intermediate command gradation value Sb is set as the correction value Hm for middle dot, and in the case of including a lot of pixel data forming the middle dots to make the concentration of the line region intermediate, it is possible to correct the number of the pixel data based on the correction value Hb (=Hm) for intermediate concentration. The correction value Hc of the dense command gradation value Sc is set as the correction value Hl for large dot, and in the case of including a lot of pixel data forming the large dots to make the concentration of the line region dense, it is possible to correct the number of the pixel data based on the correction value Hc (=Hl) for dense concentration. For this reason, the correction can be performed on the basis of the concentration, thereby solving the concentration unevenness more and more. In this instance, it is not limited to use the high gradation correction value H stored in the memory 13 of the printer 1, and the correction values Hs, Hm and Hl for each dot which are different from the high gradation correction value H may be differently set, and be stored in the memory 13 of the printer 1.

### Concentration Correction Processing

### Example 3

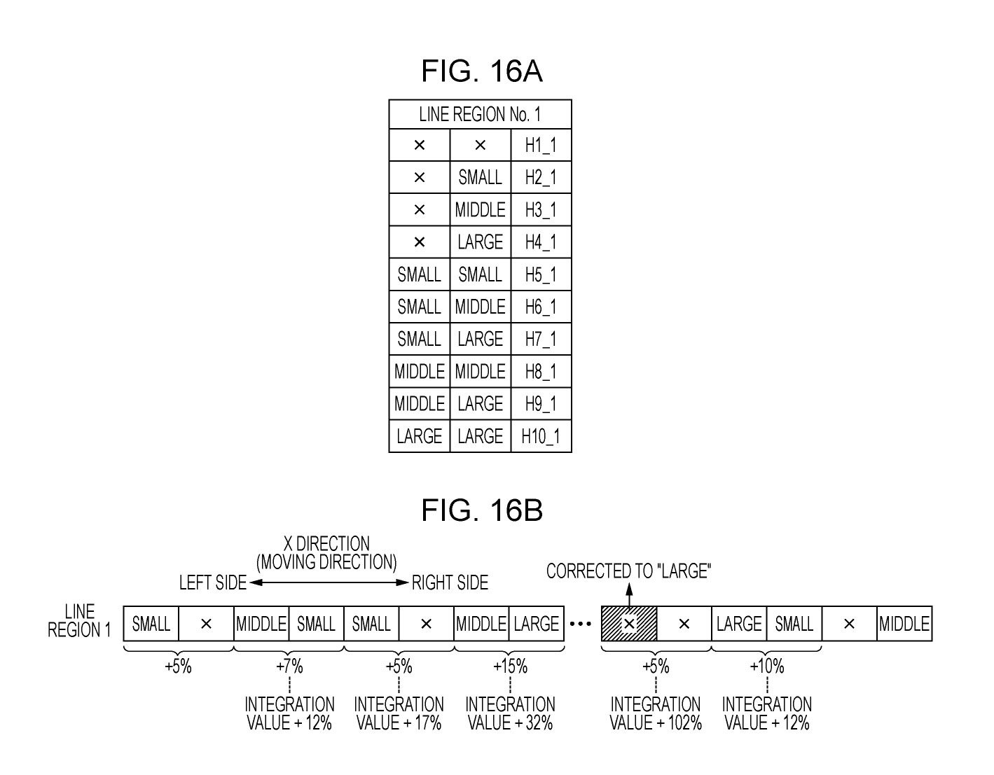

FIG. 16A shows a correction value for the pixel data of 4 gradations used in Example 3, and FIG. 16B is a view showing a shape of correcting the pixel line data in Example 3. In the above-described embodiment, the pixel data of 4 gradations from other program is corrected by using the high gradation correction value H (FIG. 9) stored in the memory 13 of the printer 1, but it is not limited thereto. New correction value H for 4 gradations may be set. The correction value H for 4 gradations is set for every line region (every pixel line data). Further, the correction value H for 4 gradations is set to densely print the line region which is visually recognized to be thin, and the correction value H is set to thinly print the line region which is visually recognized to be dense, thereby solving the unevenness in concentration more and more.

In Example 3, as shown in FIG. 16A, the correction value H is determined for every two pixel data (every the predetermined number of pixel data). Since one pixel datum is expressed by 4 gradations, the combination of 2 pixel data is 10. For this reason, the number of the correction values H for 4 gradations is set as 10. In this instance, it is not concerned in the arrangement order of two pixel data. For example, according to the correction value table (FIG. 16A) of the line region 1, in the case in which both of 2 pixel data express “no dot exists”, the correction value is set “H1_1”. In the case in which one pixel data expresses “no dot exists” and the other pixel data expresses “small dot formation”, the correction value H is set “H2_1”.

Further, as shown in FIG. 10, in the printer 1 according to this embodiment, as the gradation value is increased, the high gradation correction value H is increased, so that the correction amount of the concentration is increased. For this reason, in the case in which all of 2 pixel data are “no dot exists” or “small dot formation”, the line region corresponding to the pixel data is supposed as the line region of which the concentration is relatively thin. For this reason, in the combination of the pixel data in which the dot is not formed or the small dots are formed, the correction value H may be set as a relatively low value. By contrast, in the combination of the pixel data in which the large dots are formed, the correction value H may be set as a relatively high value. In this way, it is possible to correct the concentration in accordance with the concentration of the line region.

The concentration correction processing unit 15 determines the correction value for every two pixel data in the order in the X direction from the left side of the pixel line data corresponding to one line region, and then integrates the correction values. For example, in FIG. 16B, in the pixel line data corresponding to the line region 1, the combination of two pixel data at the leftmost side in the X direction is “small dot formation” and “no dot exists”. The concentration correction processing unit 15 determines the correction value +5% corresponding to the two pixel data by referring to the correction value table (FIG. 16A). Then, the concentration correction processing unit 15 determines the correction value “+7%” corresponding to the two pixel data based on the combination (middle dot formation and small dot formation) of 3^{rd} and 4^{th} two pixel data from the left side. The concentration correction processing unit 15 integrates the correction values “+5%” and “+7%” of the previous two pixel data to calculate an integrated value.

In this way, the concentration correction processing unit 15 determines the correction values H for every two pixel line data, integrates the correction values H to calculate the integrated value, and corrects the two pixel line data, at the point of time when the integrated value reaches 100%. In FIG. 16B, in two pixel data having integrated value of 102%, one pixel data is converted from “no dots exists” into “large dot formation”. In this instance, both tables of two pixel data may be converted, and the dot size may be increased by one step. Further, in the case in which two pixel data are “large dot formation”, the neighboring pixel data may be converted. By contrast, in the case in which the line region is thinly printed, at the time in which minus correction value H is set and the integrated value reaches “−100%”, the dot size of two pixel data is corrected to be small, or the dot is not formed.

After the integrated value reaches +100% or −100%, the concentration correction processing unit 15 determines the correction value of the next two pixel data by using a value which subtracts 100% from the integrated value, as an integrated value, and then again integrates the correction values. In this way, it is possible to perform the concentration correction processing with respect to the pixel data of 4 gradations received from other program.

### Other Embodiments

While the printing system including an ink jet printer is described in each of the embodiments, the disclosure on the method of correcting the concentration unevenness is included. The embodiments are intended not to definitively interpret the invention but to facilitate comprehension thereof. It is apparent to those skilled in the art that the invention can be modified and varied, without deviating from its teachings, and includes its equivalents. In particular, the embodiments described below are contained in the invention.

### Regarding Other Printers

In the above-described embodiment, the serial printer repeating the operation in which the head 41 moves in a direction intersecting the nozzle line to form the image and the operation in which the medium is transported in a nozzle line direction is given by an illustration, but it is not limited thereto. For example, it can be applied to a line printer having nozzles extended in parallel in the moving direction across a width of paper, in which the medium is continuously transported under the extended nozzle lines. In addition, the invention may be applied to a printer which forms an image by repeatedly performing an operation in which a head moves in a transport direction of a continuous sheet with respect to the continuous sheet transported in a printing region to form an image, and an operation in which a plurality of heads move in a paper widthwise direction intersecting the transport direction, forms an image and then transports the continuous sheet in the transport direction.

### Regarding the Fluid Ejecting Apparatus

In the above-described embodiment, the ink jet printer is illustrated as the fluid ejecting apparatus, but it is not limited thereto. It can be applied to various industrial apparatuses as a fluid ejecting apparatus, in addition to a printer (printing apparatus). For example, the invention can be applied to, for example, a printing apparatus for transferring a pattern on clothes, a display fabricating apparatus, such as a color-filter fabricating apparatus or an organic EL fabricating apparatus, a DNA chip fabricating apparatus for fabricating a DNA chip by applying a solution dissolved with DNA on a chip. Further, it is not limited to the ejection of liquid, and, for example, it may be applied to an apparatus for ejecting a fluid such as particles.

Further, the method for ejecting the fluid includes a piezoelectric method for ejecting the fluid by applying a voltage to a driving element (a piezoelectric element) to expand and contract an ink chamber, and a thermal method for ejecting the fluid by generating bubbles in the nozzles using a thermal element.

What is claimed is:

1. A fluid ejecting apparatus comprising:
(A) a nozzle line having nozzles which eject fluid onto a medium and are lined up in a predetermined direction;
(B) a moving mechanism relatively moving the nozzle line and the medium in a direction intersecting the predetermined direction; and
(C) a control unit that ejects the fluid from the nozzle line while relatively moving the nozzle line and the medium in the intersecting direction by using the moving mechanism, based on pixel data of the predetermined number of gradations according to certain kinds of dots which can be formed by the fluid ejected from the nozzles, the control unit correcting the pixel data of the predetermined number of gradations in accordance with the correction value set for every image line data which is the plurality of pixel data lined up in a direction corresponding to the intersecting direction in the pixel data.

2. The fluid ejecting apparatus according to claim 1, wherein it is identified whether the received pixel data of the predetermined number of gradations is correction completed data which is converted to pixel data of the predetermined number of gradations after correcting the pixel data of the high number of gradations by the correction value corresponding to the high number of gradations higher than the predetermined number of gradations, or is a pre-correction data which is not corrected by the correction value corresponding to the high number of gradations, and
if the received pixel data of the predetermined number of gradations is the pre-correction data, the pre-correction data is corrected by the correction value.

3. The fluid ejecting apparatus according to claim 2, wherein, among the plurality of pixel data belonging to the certain pixel line data, the predetermined number of pixel data based on the correction value corresponding to the pixel line data are corrected.

4. The fluid ejecting apparatus according to claim 2, wherein the correction number correcting the pixel data of the predetermined number of gradations is a correction value corresponding to the high number of gradations.

5. The fluid ejecting apparatus according to claim 4, wherein the correction value corresponding to the high number of gradations is set with respect to a plurality of gradation values;
the correction value corresponding to a first gradation value among the plurality of gradation values is set as a first correction value corresponding to a first dot among the dots which can be formed;
the correction value corresponding to a second gradation value among the plurality of gradation values is set as a second correction value corresponding to a second dot among the dots which can be formed;
among the pixel data which forms the first dot, of the plurality of pixel data belonging to the pixel line data, the predetermined number of the pixel data is corrected on the basis of the first correction value corresponding to the pixel line data; and
among the pixel data which forms the second dot, of the plurality of pixel data belonging to the certain pixel line data, the predetermined number of the pixel data is corrected on the basis of the second correction value corresponding to the pixel line data.

6. The fluid ejecting apparatus according to claim 1, wherein the correction value in accordance with combination of the predetermined number of pixel data of the predetermined number of gradations is stored;
in order from one side of a corresponding direction in the plurality of pixel data belonging to the pixel line data, the correction value in accordance with the combination of the predetermined number of pixel data is determined for every predetermined number of pixel data;
an integrated value is calculated by integrating the determined correction value; and
when the integrated value reaches a threshold value, the pixel data are corrected.

7. The fluid ejecting apparatus according to claim 1, wherein in a case in which a region on the medium corresponding to the pixel line data is corrected to be thin, a quantity of the fluid to be ejected from the nozzle is reduced based on the pixel data to be corrected, and
in a case in which a region on the medium corresponding to the pixel line data is corrected to be dense, a quantity of the fluid to be ejected from the nozzle is increased based on the pixel data to be corrected.

8. A method for correcting pixel data in fluid ejecting apparatus relatively moving a nozzle line having nozzles which eject a fluid onto a medium and are arranged lined up in a predetermined direction, and the medium in a direction intersecting the predetermined direction, in which the fluid ejecting apparatus ejects the fluid from the nozzle line, while relatively moving the nozzle line and the medium in the intersecting direction, based on pixel data of the predetermined number of gradations according to certain kinds of dots which are formed by the fluid ejected from the nozzles,
wherein the pixel data of the predetermined number of gradations are corrected in accordance with the correction value set for every pixel line data which is the plurality of pixel data lined up in a direction corresponding to intersecting direction in the pixel data.
